(19) United States
(12) Patent Application Publication
(10) Pub. No.: US 2010/0230932 A1
(43) Pub. Date: Sep. 16, 2010

(54) Safety Sentry

(76) Inventor: Karl Pratt, Granbury, TX (US)

Correspondence Address: WILSON DANIEL SWAYZE, JR., 3804 CLEARWATER CT., PLANO, TX, 75025, US

(21) Appl. No.: 12/484,908

(22) Filed: Jun. 15, 2009

Related U.S. Application Data
(60) Provisional application No. 61/159,135, filed on Mar. 11, 2009.

(51) Int. Cl. B60D 1/60

(52) U.S. Cl. 280/507

(57) ABSTRACT

A trailer hitch guide for restraining a trailer hitch may include an upper member to restrain the movement of the trailer hitch and a lower member to connect to the upper member and to connect to a vehicle. The upper member may be rotatably connected to the lower member. The upper member may be substantially U-shaped. The lower member may be substantially U-shaped. The upper member may include a upper side section. The upper side section may include a upper arm section. The lower member may include a lower side section. The lower side section may include a lower arm section. The upper arm section may be connected to a upper connecting plate. The lower arm section may be connected to a lower arm connecting plate which may cooperate with the upper connecting plate to restrain the upper member from rotating with respect to the lower member. The upper connecting plate may be connected to the lower connecting plate with a fastening device.

### PRIORITY

The present invention claims priority under 35 USC section 119 and based upon a provisional application with a Ser. No. of 61/159,135 which was filed on Mar. 11, 2009

### FIELD OF THE INVENTION

The present invention relates to trailer hitches and more particularly to a device to prevent the trailer hitch from slipping off the trailer towing ball.

### BACKGROUND

Conventional trailer hitch assemblies used in towing recreational trailers such as mobile homes, campers, and boat trailers, and used in towing utility trailers, are generally comprised of a hitch ball that is securely attached to the rearward end of the towing vehicle, and a hitch coupler that is securely attached to a forward end of a tongue assembly extending from the trailer. Often, the hitch ball of a conventional hitch assembly is mounted on a tow bar, and the tow bar is slidably received in a receiver channel that is secured to the vehicle. The tow bar is releasably secured in the receiver channel when the vehicle is towing a trailer, and is removed from the channel and stored when not in use. However, for the most part, the two component parts of a conventional trailer hitch assembly are fixedly secured to either the tow vehicle or the trailer, and are not capable of being moved relative to the tow vehicle or trailer to which they are secured.

Typically when a trailer is attached to the vehicle, the trailer hitch may include a set of metal chains to secure the trailer to the vehicle. These chains often provide an effective security device, but may be a nuisance to use and a safety hazard. If the trailer becomes unattached from the trailer ball, the flexibility of the chains may result in the trailer becoming unstable and may result in the vehicle overturning or losing control. These chains may need to be replaced regularly and consequently the chains may be a liability and a nuisance to use.

### SUMMARY

A trailer hitch guide for restraining a trailer hitch may include an upper member to restrain the movement of the trailer hitch and a lower member to connect to the upper member and to connect to a vehicle.

The upper member may be rotatably connected to the lower member.

The upper member may be substantially U-shaped.

The lower member may be substantially U-shaped.

The upper member may include a upper side section.

The upper side section may include a upper arm section.

The lower member may include a lower side section.

The lower side section may include a lower arm section.

The upper arm section may be connected to a upper connecting plate.

The lower arm section may be connected to a lower arm connecting plate which may cooperate with the upper connecting plate to restrain the upper member from rotating with respect to the lower member.

The upper connecting plate may be connected to the lower connecting plate with a fastening device.

The fastening device may be a bolt and nut.

The trailer hitch guide may include a locking device to prevent the rotation of the upper member with respect to the lower member.

The lower member may include a aperture to accommodate a hitching device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the safety sentry of the present invention;

FIG. 2 illustrates an exploded view of the safety sentry of the present invention;

FIG. 3 illustrates a side view of the safety sentry of the present invention;

FIG. 4 illustrates a cross-sectional view of the safety sentry in an open position;

FIG. 5 illustrates a cross-sectional view of the safety sentry in a closed position;

FIG. 6 illustrates a top view of the safety sentry of the present invention;

FIG. 7 illustrates a bottom view of the safety sentry of the present invention;

FIG. 8 illustrates a perspective view of the safety sentry of the present invention.

### DETAILED DESCRIPTION

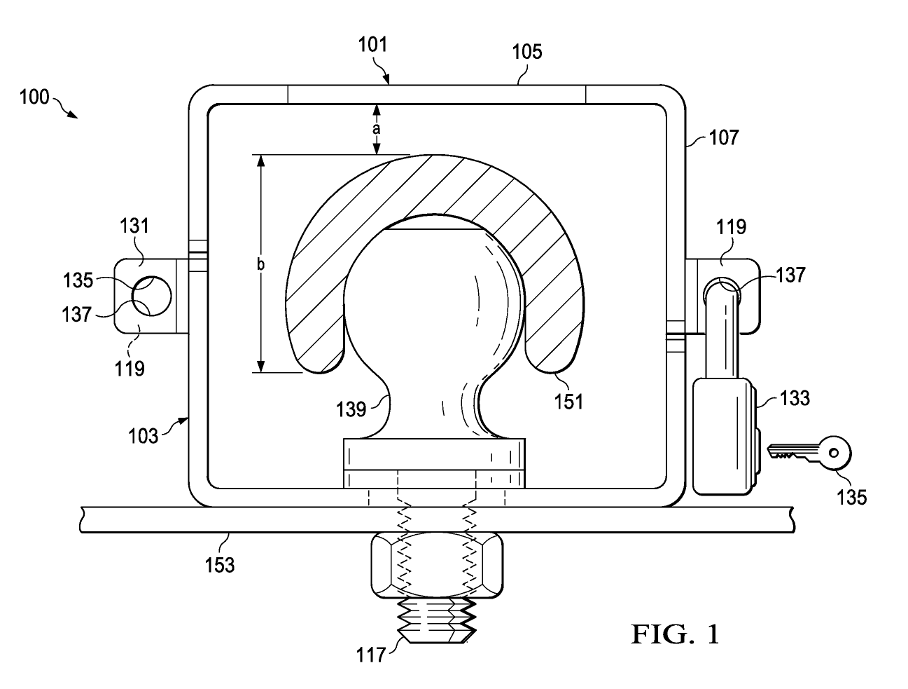

FIG. 1 illustrates a front perspective view of the safety sentry 100 which may be a trailer hitch guide to retain a trailer hitch 151 being used in conjunction with a hitching device 139 which may be a hitching ball and which may be connected to a trailer hitch 151 in a first position which may be closed. The hitching device 139 may be connected to a bumper 153 of a vehicle or other connection points to the vehicle which may include a fifth wheel. The safety sentry 100 may be formed from rigid material such as metal plates and/or sheets and may be formed from integral portions or welded portions. FIG. 1 illustrates that the safety sentry 100 may include an upper member 101 which may be substantially an inverted U-shaped member or may be a curved shape member or other appropriate shape and a lower member 103 which may be a substantially U-shaped member or may be a curved shape member or other appropriate shape.

The upper member 101 may include an upper top section 105 which may extend between a pair of opposing upper side sections 107 which may terminate in a downward extending upper arm member 109 which may connect to a upper connecting plate 119 to connect to a lower connecting plate 131.

The lower member 103 may include a lower bottom section 111 which may extend between opposing lower side section 113 which may terminate in a upward extending lower arm section 115 to connect to the lower connecting plate 131 to connect to the upper connecting plate 119. The lower bottom section 111 may include a hitching device aperture 155 to cooperate with a shaft of a hitching device 139.

The upper connecting plate 119 may include an upper aperture 135 to cooperate with a lower aperture 137 of the lower connecting plate 131. A fastening device 117 such as a bolt may extend through the upper aperture 135 and the lower aperture 137 in order to connect the upper member 101 to the lower member 103.

FIG. 1 additionally illustrates a locking device 133 and key 135 to lock the safety sentry 100 so that the upper member 101 cannot be disconnected from the lower member 103.

FIG. 1 illustrates that the space ‘a’ between the apex of the trailer hitch 151 and the bottom surface of the upper top section 105 is sufficiently small so that if the vehicle or trailer should hit a bump or other obstacle the trailer hitch 151 cannot be raised sufficiently in order for the trailer hitch 151 to clear the hitching device 139 as shown by the distance ‘b’. Consequently, the trailer hitch 151 is impeded from leaving the trailer hitch 151 by the interaction of the bottom surface of the upper top section 105 and the trailer hitch 151. This eliminates the need for chains and the associated problems with these chains.

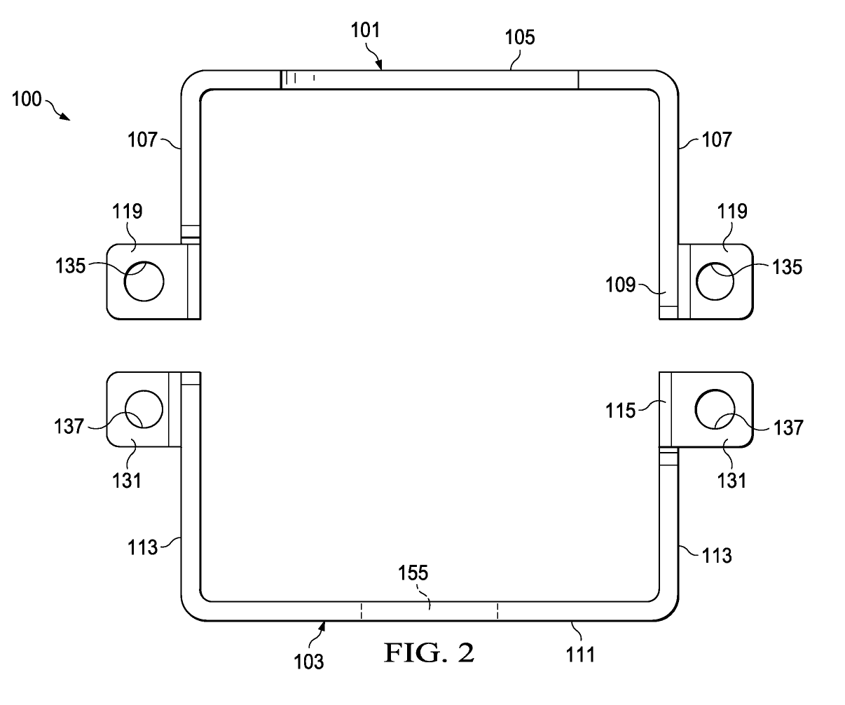

FIG. 2 illustrates an exploded front view of the safety sentry 100. FIG. 2 illustrates that the safety sentry 100 may include an upper member 101 which may be substantially an inverted U-shaped member or may be a curved shape member or other appropriate shape and a lower member 103 which may be a substantially U-shaped member or may be a curved shape member or other appropriate shape.

The upper member 101 may include an upper top section 105 which may extend between a pair of opposing upper side sections 107 which may terminate in a downward extending upper arm member 109 which may connect to a upper connecting plate 119 to connect to a lower connecting plate 131.

The lower member 103 may include a lower bottom section 111 which may extend between opposing lower side section 113 which may terminate in a upward extending lower arm section 115 to connect to the lower connecting plate 131 to connect to the upper connecting plate 119. The lower bottom section 111 may include a hitching device aperture 155 to cooperate with a shaft of a hitching device 139 as shown in FIG. 1.

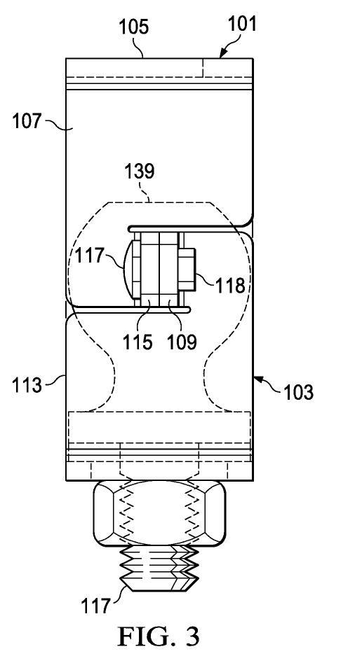

The upper connecting plate 119 may include an upper aperture 135 to cooperate with a lower aperture 137 of the lower connecting plate 131. A fastening device 117 is shown in FIG. 3 such as a bolt may extend through the upper aperture 135 and the lower aperture 137 in order to connect the upper member 101 to the lower member 103. The bolt 117 may be connected to a nut 118.

FIG. 3 illustrates a side view of the safety sentry 100 and illustrates the upper side section 107 and the upper arm section 109 extending from the upper side section 107. FIG. 3 additionally illustrates the lower side section 113 and the lower arm section 115 which extends from the lower side section 113. FIG. 3 additionally illustrates the fastening device 117 and the nut 118.

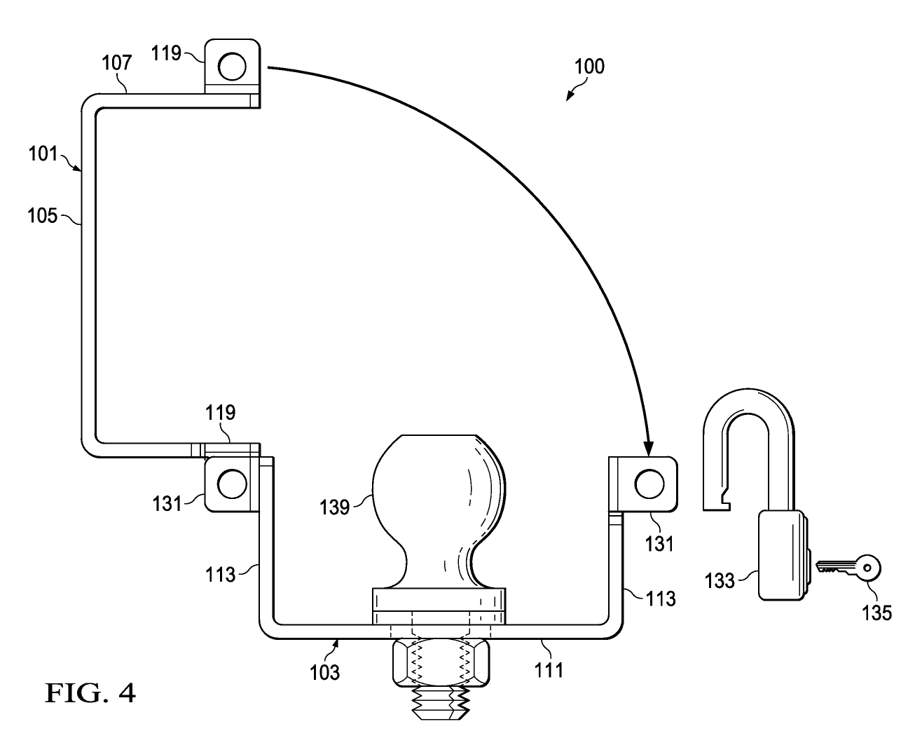

FIG. 4 illustrates a cross section view of the safety sentry 100 being used in conjunction with a hitching device 139 which may be a hitching ball and which may be connected to a trailer hitch 151 in a second position which may be open. FIG. 4 illustrates that the top section 105 has been rotated with respect to the bottom section 111 so that the trailer hitch 151 as illustrated in FIG. 1 may be removed or inserted on the hitching device 139. The hitching device 139 may be connected to a bumper 153 as shown in FIG. 1 of a vehicle or other connection points to the vehicle which may include a fifth wheel. FIG. 4 illustrates that the safety sentry 100 may include an upper member 101 which may be substantially an inverted U-shaped member or may be a curved shape member or other appropriate shape and a lower member 103 which may be a substantially U-shaped member or may be a curved shape member or other appropriate shape.

The upper member 101 may include an upper top section 105 which may extend between a pair of opposing upper side sections 107 which may terminate in a downward extending upper arm member 109 which may connect to a upper connecting plate 119 to connect to a lower connecting plate 131.

The lower member 103 may include a lower bottom section 111 which may extend between opposing lower side section 113 which may terminate in a upward extending lower arm section 115 to connect to the lower connecting plate 131 to connect to the upper connecting plate 119. The lower bottom section 111 may include a hitching device aperture 155 to cooperate with a shaft of a hitching device 139.

The upper connecting plate 119 may include an upper aperture 135 to cooperate with a lower aperture 137 of the lower connecting plate 131. A fastening device 117 such as a bolt may extend through the upper aperture 135 and the lower aperture 137 in order to connect the upper member 101 to the lower member 103.

FIG. 4 additionally illustrates a locking device 133 and key 135 to lock the safety sentry 100 so that the upper member 101 cannot be disconnected from the lower member 103.

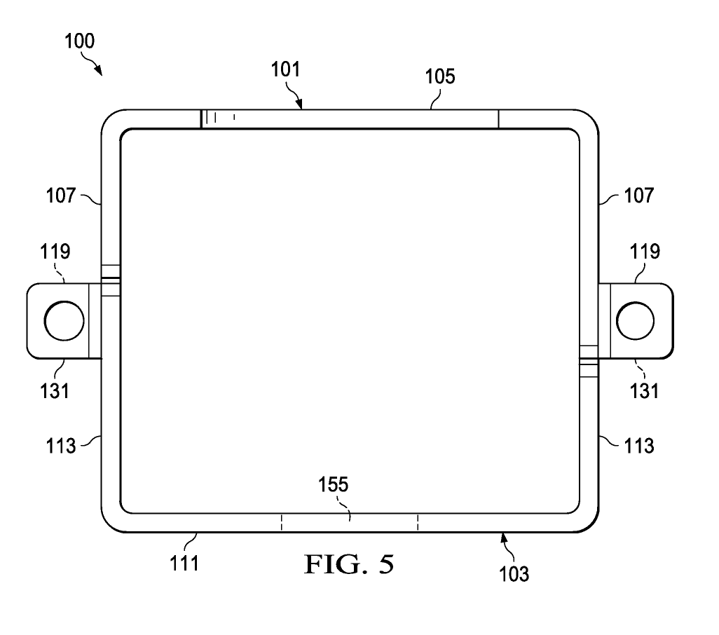

FIG. 5 illustrates a front view of the safety sentry 100. FIG. 5 illustrates that the safety sentry 100 may include an upper member 101 which may be substantially an inverted U-shaped member or may be a curved shape member or other appropriate shape and a lower member 103 which may be a substantially U-shaped member or may be a curved shape member or other appropriate shape.

The upper member 101 may include an upper top section 105 which may extend between a pair of opposing upper side sections 107 which may terminate in a downward extending upper arm member 109 (not shown) which may connect to a upper connecting plate 119 to connect to a lower connecting plate 131.

The lower member 103 may include a lower bottom section 111 which may extend between opposing lower side section 113 which may terminate in a upward extending lower arm section 115 (not shown) to connect to the lower connecting plate 131 to connect to the upper connecting plate 119. The lower bottom section 111 may include a hitching device aperture 155 to cooperate with a shaft of a hitching device 139 as shown in FIG. 1.

The upper connecting plate 119 may include an upper aperture 135 to cooperate with a lower aperture 137 of the lower connecting plate 131. A fastening device 117 is shown in FIG. 3 such as a bolt may extend through the upper aperture 135 and the lower aperture 137 in order to connect the upper member 101 to the lower member 103. The bolt 117 may be connected to a nut 118.

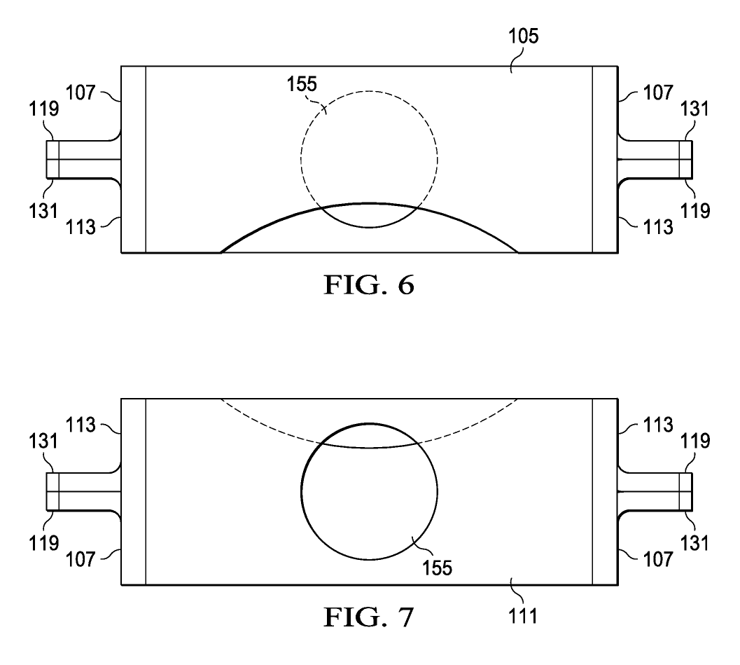

FIG. 6 illustrates a top view of the safety sentry 100 and illustrates the upper top section 105 which extends between the upper side sections 107 which may be connected to the upper connecting plate 119 for cooperation with the lower connecting plate 113. The lower connecting plate 131 may be connected to the lower side section 113.

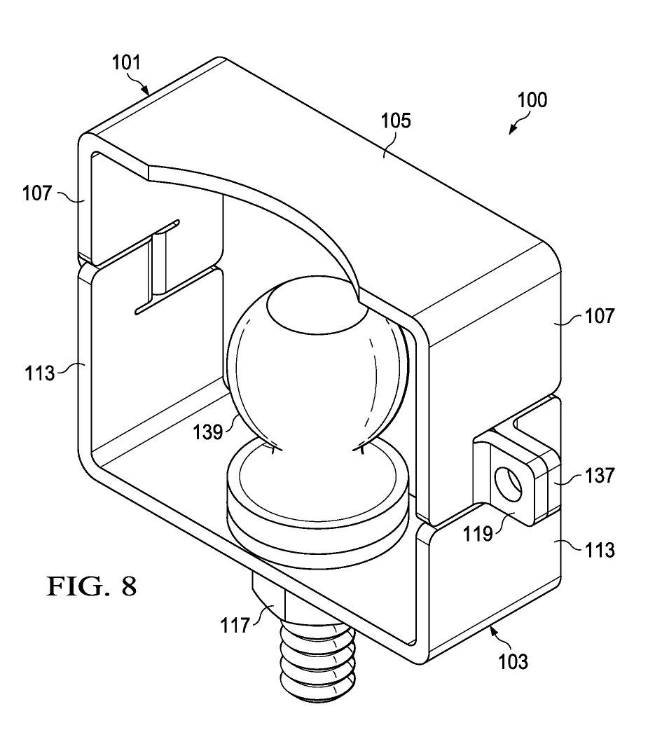

FIG. 7 illustrates a bottom view of the safety sentry 100 and illustrates the lower bottom section 111 which extends between the lower side sections 113 which may be connected to the lower connecting plate 131 for cooperation with the upper connecting plate 119. The upper connecting plate 119 may be connected to the upper side section 107.

FIG. 8 illustrates that the safety sentry 100 may include an upper member 101 which may be substantially an inverted U-shaped member or may be a curved shape member or other appropriate shape and a lower member 103 which may be a substantially U-shaped member or may be a curved shape member or other appropriate shape.

The upper member 101 may include an upper top section 105 which may extend between a pair of opposing upper side sections 107 which may terminate in a downward extending upper arm member 109 which may connect to a upper connecting plate 119 to connect to a lower connecting plate 131.

The lower member 103 may include a lower bottom section 111 which may extend between opposing lower side section 113 which may terminate in a upward extending lower arm section 115 to connect to the lower connecting plate 131 to connect to the upper connecting plate 119.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A trailer hitch guide for restraining a trailer hitch, comprising:
an upper member to restrain the movement of the trailer hitch;
a lower member to connect to the upper member and to connect to a vehicle;
wherein the upper member is rotatably connected to the lower member.

2) A trailer hitch guide for restraining a trailer hitch as in claim 1, wherein the upper member is substantially U-shaped.

3) A trailer hitch guide for restraining a trailer hitch as in claim 1, wherein the lower member is substantially U-shaped.

4) A trailer hitch guide for restraining a trailer hitch as in claim 1, wherein the upper member includes a upper side section.

5. A trailer hitch guide for restraining a trailer hitch as in claim 4, wherein the upper side section includes a upper arm section.

6) A trailer hitch guide for restraining a trailer hitch as in claim 5, wherein the lower member includes a lower side section.

7) A trailer hitch guide for restraining a trailer hitch as in claim 6, wherein the lower side section includes a lower arm section.

8) A trailer hitch guide for restraining a trailer hitch as in claim 7, wherein the upper arm section is connected to a upper connecting plate.

9) A trailer hitch guide for restraining a trailer hitch as in claim 8, wherein the lower arm section is connected to a lower arm connecting plate which cooperates with the upper connecting plate to restrain the upper member from rotating with respect to the lower member.

10) A trailer hitch guide for restraining a trailer hitch as in claim 9, wherein the upper connecting plate is connected to the lower connecting plate with a fastening device.

11) A trailer hitch guide for restraining a trailer hitch as in claim 10, wherein the fastening device is a bolt and nut.

12) A trailer hitch guide for restraining a trailer hitch as in claim 1, wherein the trailer hitch guide further includes a locking device to prevent the rotation of the upper member with respect to the lower member.

13) A trailer hitch guide for restraining a trailer hitch as in claim 1, wherein the lower member includes a aperture to accommodate a hitching device.
